(19) United States
(12) Patent Application Publication
(10) Pub. No.: US 2009/0138909 A1
(43) Pub. Date: May 28, 2009

(54) RECORDING APPARATUS

(76) Inventor: Hiroaki Shimazaki, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/299,511

(22) PCT Filed: May 29, 2007
(86) PCT No.: PCT/JP2007/060853

§ 371 Date: Nov. 4, 2008

(30) Foreign Application Priority Data
Jun. 1, 2006 (JP) 2006-154056

(51) Int. Cl. H04N 5/445; H04N 7/00

(52) U.S. Cl. 725/37; 386/95

(57) ABSTRACT

Provided is a recording apparatus that generates and records an on-screen menu having a different resolution depending on a type of a loaded recording medium. The recording-reproducing apparatus (100) includes at least a medium information detecting unit (116) that detects attribute information of a loaded recording medium and transmits a result of the detection to an image generating unit (111); the image generating unit (111) that generates a high-resolution on-screen menu when the recording medium information detecting unit (116) detects that the recording medium supports recording of an image having a high resolution, or a lower-resolution on-screen menu when the medium information detecting unit (116) detects that the loaded recording medium does not supports recording of an image having the high resolution; and a recording controlling unit (108) that records the on-screen menu generated by the image generating unit (111) on a recording medium (10).

### TECHNICAL FIELD

The present invention relates to a recording apparatus that can record, on recording media such as DVDs, Blu-ray discs, and memory cards, data for an on-screen menu or the like that lists content items recorded on the recording media.

### BACKGROUND ART

Conventional recording apparatuses generate and record disc menus that list thumbnail images of content data on media when finalizing write-once media or when recording the content data on rewritable media (for example, see Patent Reference 1).

FIG. 1 shows an example of a display of a disc menu displayed by a conventional recording apparatus. The conventional disc menu displays content items recorded on a recording medium as a list of thumbnail images so as to help users select from the content items. As shown in FIG. 1, the conventional recording-reproducing apparatuses record, on recording media, disc menus having a size (particularly, with regard to the number of thumbnail images) appropriate for a standard resolution, an SDTV resolution.

### Patent Reference 1: Japanese Unexamined Patent Application Publication No. 2004-5776

### DISCLOSURE OF INVENTION

### Problems that Invention is to Solve

In recent years, multi-drive recording apparatuses have been commercialized, which can record standard SDTV images Attachment “B” on discs such as DVDs, and high-resolution images on next-generation discs, for example, HDTV images on Blu-ray discs. However, such multi-drive recording apparatuses have a problem of lacking a function for recording on-screen menus having different resolutions depending on a type of a recording medium.

When next-generation discs or memory cards become available for recording disc menus, high-grade menu images that support high-resolution images will be necessary for on-screen menus. Thus, the multi-drive recording apparatuses that can record both SDTV images and HDTV images will be required to have a function for changing a resolution of an on-screen menu depending on a type of a recording medium so as to record the on-screen menu.

The multi-drive recording-reproducing apparatuses will also be required to reproduce menu images recorded at the SDTV resolution in order to keep compatibility with conventional DVD recording-reproducing apparatuses or memory card recording-reproducing apparatuses that support only SDTV.

Further, owing to the advancement of image compression technology, recording apparatuses that can record with high-resolution video quality are being developed to record high-resolution images on DVDs or recording media other than discs such as SD memory cards by compressing the high-resolution images to SDTV images equivalent.

The present invention, conceived to address this problem, has an object of providing a recording apparatus that can generate an on-screen menu at a resolution that differs depending, for example, on attribute information of a loaded recording medium, and automatically record the on-screen menu on the loaded recording medium.

### Means to Solve the Problems

In order to achieve the above-mentioned object, the recording apparatus according to the present invention is capable of recording an image on a first recording medium and on a second recording medium, the second recording medium supporting recording of a high-resolution image compared to the first recording medium, and includes: a detecting unit configured to detect whether a loaded recording medium is the first recording medium or the second recording medium according to information regarding the loaded recording medium; an on-screen menu generating unit configured to generate an on-screen menu having a high resolution when the detecting unit detects that the loaded recording medium is the second recording medium, and an on-screen menu having a resolution lower than the high resolution when the detecting unit detects that the loaded recording medium is the first recording medium; and a recording unit configured to record, on the loaded recording medium, the on-screen menu generated by the on-screen menu generating unit.

When the detecting unit detects that the loaded recording medium is the above-mentioned first recording medium, for example, a conventional DVD that supports recording only at an SDTV resolution, this structure will record a disc menu having an SDTV resolution on the conventional DVD via the recording unit. When the detecting unit detects that the loaded recording medium is the above-mentioned second recording medium, for example, a new-standard DVD that supports HDTV recording at an increased image compression rate or a Blu-ray disc that supports recording at an HDTV resolution, this structure will record a disc menu having the HDTV resolution via the recording unit.

Further, the detecting unit of the recording apparatus according to the present invention is configured to detect whether the loaded recording medium is the first recording medium or the second recording medium according to a type of the loaded recording medium; the on-screen menu generating unit is configured to generate the on-screen menu having the high resolution when the detecting unit detects that the loaded recording medium is the second recording medium, or the on-screen menu having the resolution lower than the high resolution when the detecting unit detects that the loaded recording medium is the first recording medium; and the recording unit is configured to record, on the loaded recording medium, the on-screen menu generated by the on-screen menu generating unit.

Further, the detecting unit of the recording apparatus according to the present invention is configured to detect whether the loaded recording medium is the first recording medium or the second recording medium according to a capacity of the loaded recording medium; the on-screen menu generating unit is configured to generate the on-screen menu having the high resolution when the detecting unit detects that the loaded recording medium is the second recording medium, or the on-screen menu having the resolution lower than the high resolution when the detecting unit detects that the loaded recording medium is the first recording medium; and the recording unit is configured to record, on the loaded recording medium, the on-screen menu generated by the on-screen menu generating unit.

These structures will detect a type of a recording medium such as DVD or Blu-ray disc using the detecting unit, generate an on-screen menu having a high resolution or a low resolution according to the detected type of the recording medium, and then record the generated on-screen menu on the recording medium.

Further, the recording apparatus is capable of recording a disc menu according to a type of a loaded recording medium. When a loaded memory card has a small capacity that allows recording for a sufficient recording time only at an SDTV resolution, the recording apparatus will record a disc menu having the SDTV resolution. When a loaded medium is, for example, a Blu-ray disc having a large capacity that assures a sufficient recording time even at the HDTV resolution, the recording apparatus will record a disc menu having not the SDTV resolution, which does not make use of capability of Blu-ray discs for recording at the high resolution, but the HDTV resolution.

In order to achieve the object, the present invention can be embodied as a recording method that has characteristic units of the recording apparatus as steps, or a program that causes a computer to execute the steps. Obviously, such a program can be distributed via recording media such as CD-ROMs or transmission media such as the Internet.

### EFFECTS OF THE INVENTION

A recording-reproducing apparatus according to the present invention is capable of detecting information regarding a type, a capacity, or the like of a loaded recording medium, changing a resolution of a disc menu to generate according to a result of the detecting, and recording the disc menu on the recording medium.

Owing to an on-screen menu recorded by the recording apparatus at a resolution appropriate for the recording medium according to the type of the recording medium, a multi-drive recording-reproducing apparatus that supports recording of both SDTV and HDTV images reproduces the on-screen menu compatible with either of a high-resolution and a standard resolution, leading to improved usability.

Further, an on-screen menu is displayed properly even when a recording medium is loaded for compatible reproduction on a non-multi-drive, conventional recording-reproducing apparatus with a single function or on a memory card recording-reproducing apparatus that supports only SDTV.

### BRIEF DESCRIPTION OF DRAWINGS

FIG. 1 shows a display example of an on-screen disc menu displayed by a conventional recording-reproducing apparatus;

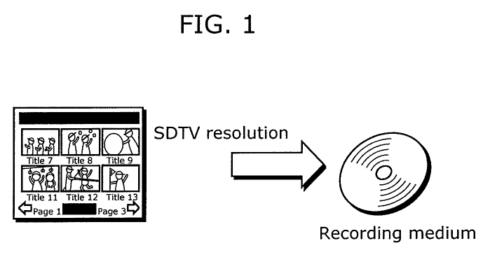

FIG. 2 shows a hardware configuration of a recording-reproducing apparatus described in an embodiment according to the present invention;

FIG. 3 shows a hardware configuration of a recording-reproducing apparatus described in the embodiment according to the present invention;

FIG. 4 shows a data structure in the menu file described in the embodiment according to the present invention;

FIG. 5 shows a display example of an on-screen disc menu described in the embodiment according to the present invention; and

FIG. 6 is a flow chart showing an operating procedure in which the recording-reproducing apparatus according to the present invention generates and records an on-screen menu.

### NUMERICAL REFERENCES

10 Recording medium
100 Recording-reproducing apparatus
101 Group of lenses
102 Imaging unit
103 A/D converting unit
104 Video signal processing unit
105 Compressing-multiplexing unit
106 Recording processing unit
108 Recording controlling unit
109 Inputting unit
110 Controlling unit
111 Image generating unit
112 Display unit
113 Video signal processing unit
114 Demultiplexing-decompressing unit
115 Reproducing processing unit
116 Medium information detecting unit

### BEST MODE FOR CARRYING OUT THE INVENTION

Hereinafter, an embodiment of a recording apparatus according to the present invention is described with reference to figures.

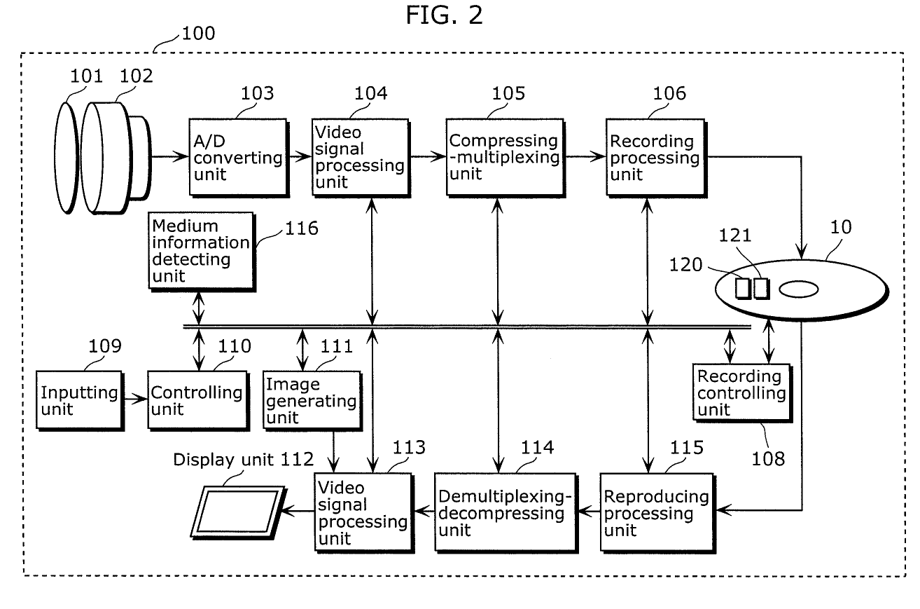

FIG. 2 shows a hardware configuration of a recording-reproducing apparatus according to the present embodiment. The recording-reproducing apparatus according to the present embodiment changes a resolution of an on-screen menu, which lists content items recorded on a recording medium, depending on a type of a recording medium, and records the on-screen menu on the recording medium properly.

As shown in FIG. 2, a recording-reproducing apparatus 100 includes a group of lenses 101, an imaging unit 102, an A/D converting unit 103, a video signal processing unit 104, a compressing-multiplexing unit 105, a recording processing unit 106, a recording controlling unit 108, an inputting unit 109, a controlling unit 110, an image generating unit 111, a display unit 112, a video signal processing unit 113, a demultiplexing-decompressing unit 114, a reproducing processing unit 115, and a medium information detecting unit 116.

The group of lenses 101 includes a plurality of optical lenses.

The imaging unit 102 includes an imaging device and captures an image entering via the group of lenses 101. The captured image is outputted as an analog signal to the A/D converting unit 103.

The A/D converting unit 103 converts the analog signal outputted from the imaging unit 102 to a digital signal. The digital signal obtained through the conversion is outputted to the video signal processing unit 104.

The video signal processing unit 104 converts, into a video signal, the digital signal outputted from the A/D converting unit 103. The video signal obtained through the conversion is outputted to the compressing-multiplexing unit 105.

The compressing-multiplexing unit 105 compresses and multiplexes the video signal outputted from the video signal processing unit 104 using a coding method such as of MPEG-2 or H.264. The video signal obtained through the multiplexing is outputted as content to the recording processing unit 106.

The recording processing unit 106 records the content outputted from the compressing-multiplexing unit 105 on a recording medium 10.

The recording controlling unit 108 records an on-screen menu generated by the image generating unit 111 on the recording medium 10 and controls a driving apparatus that drives the recording medium 10.

The inputting unit 109 receives a user operation via an inputting device. The received user operation is outputted as operation information to the controlling unit 110.

The controlling unit 110 controls the video signal processing unit 104, the compressing-multiplexing unit 105, the recording processing unit 106, the recording controlling unit 108, the image generating unit 111, the video signal processing unit 113, the demultiplexing-decompressing unit 114, and the reproducing processing unit 115 so that the recording-reproducing apparatus 100 can execute processes such as recording and reproducing. The medium information detecting unit 116 detects attribute information of a loaded recording medium, and transmits a result of the detecting to the image generating unit 111. The attribute information of the recording medium detected by the medium information detecting unit 116 is to be used for judging whether a disc menu to be recorded is of SDTV or HDTV. Such attribute information may include (i) a type of the recording medium (for example, DVD or Blu-ray disc), (ii) a capacity of the recording medium, (iii) a type of content recorded on the recording medium, or (iv) a transfer rate of the recording medium (for example, a transfer performance indicator such as Class 2 for SD memory cards). These items (i) to (iv) included in the attribute information are detailed below.

(i) Type of Recording Medium

A type of a recording medium can be detected by physical properties that differ depending on the type, such as a wavelength of light used for recording and reproducing of the medium. In this case, whether or not a disc menu to be recorded is of HDTV can be basically judged directly by the type of the recording medium (for example, for a Blu-ray disc, a disc menu to be recorded is of HDTV).

(ii) Capacity of Recording Medium

A capacity of a recording medium can be detected in partition information generated by an OS, information stored in a file system, or the like. In this case, a possible judgment method is that when a recording medium has a capacity larger than a predetermined capacity, a disc menu to be recorded is of HDTV.

(iii) Type of Content Recorded on Recording Medium

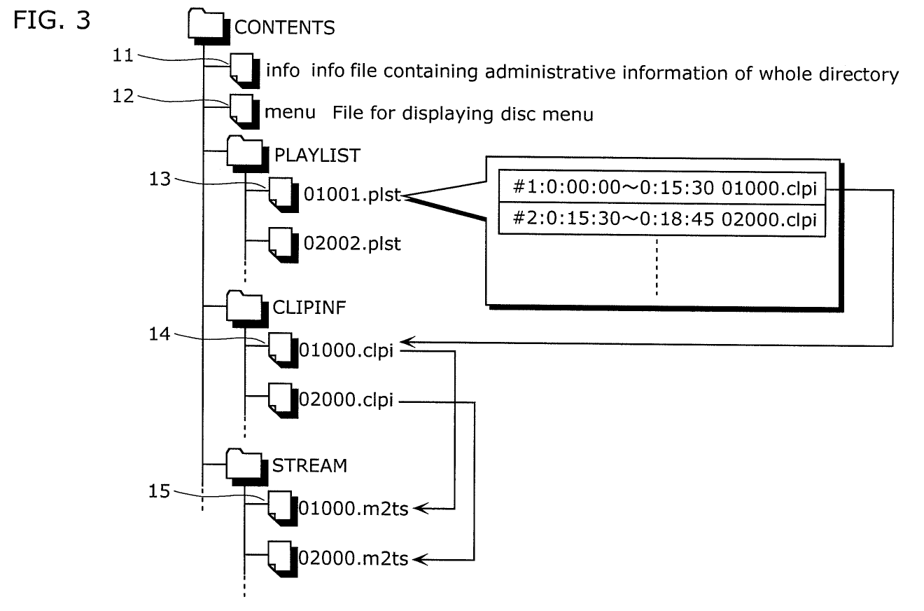

File structures of content depend on recording standards. A type of content therefore can be judged by a file structure of the content. A possible judgment method for a standard that supports recording both in HDTV and SDTV is that a resolution of a disc menu will be determined according to information that indicates whether recorded content is of HDTV or SDTV (for example, information in an info file or a CLIPINF folder of content shown in FIG. 3 mentioned later can be used). For commonly-used recording standards, such information is included in their administration files.

(iv) Transfer Rate of Recording Medium

For example, if a recording standard is set to specify that administrative information regarding transfer rates be recorded on recording media when they are manufactured, a possible judgment method is that in the case where a transfer rate higher than a predetermined value is found available by reading the administrative information, a disc menu to be recorded is of HDTV.

The following is four exemplary definitions of “a recording medium that supports recording of an image having a high resolution” judged as such by the medium information detecting unit 116.

(i) Type of Recording Medium

When the medium information detecting unit 116 can read, using a laser beam having a 405-nm wavelength, information that was embedded in a disc recording medium when, for example, the disc recording medium was manufactured, the recording medium is judged as a recording medium that supports recording of an image having a high resolution such as of HDTV.

For example, a wavelength of a laser beam used for DVDs (for SDTV) is 660 nm, and for Blu-ray discs 405 nm. Recordable optical discs have address information embedded in their recording tracks when they are manufactured.

(ii) Capacity of Recording Medium

For example, when the medium information detecting unit 116 detects that the capacity of a recording medium is larger than 10 Gbyte, the recording medium is judged as a recording medium that supports recording of an image having a high resolution such as of HDTV.

For example, single-layer DVDs (for SDTV) have a capacity of 4.7 Gbyte, and single-layer Blu-ray discs (for HDTV) have a capacity of 25 Gbyte.

(iii) Type of Content

For example, when the medium information detecting unit 116 detects that content recorded on a loaded recording medium is of HDTV, the loaded recording medium is judged as a recording medium that supports recording of an image having a high resolution such as of HDTV.

(iv) Transfer Rate of Recording Medium

For example, when the medium information detecting unit 116 detects that transfer rate of a loaded recording medium is higher than 11 Mbit/sec, the loaded recording medium is judged as a recording medium that supports recording of an image having a high resolution such as of HDTV. The present-day maximum transfer rate of the DVD-VR standard (for SDTV) is 10.08 Mbit/sec.

The image generating unit 111 generates, on the basis of a result of the detecting obtained from the medium information detecting unit 116, a menu image that lists content items recorded on the recording medium 10. Specifically, when the medium information detecting unit 116 detects that a recording medium supports recording of an image having a high resolution, the image generating unit 111 generates a high-resolution on-screen menu. When the medium information detecting unit 116 detects that a recording medium does not support recording of an image having a high resolution, the image generating unit 111 generates an on-screen menu having a resolution compatible with an SDTV image. The generated on-screen menu is recorded as administrative information 121 on the recording medium 10 using the recording controlling unit 108.

The display unit 112 displays a video signal outputted from video signal processing unit 113 on a monitor or the like.

The video signal processing unit 113 converts decompressed content outputted from the demultiplexing-decompressing unit 114 into a video signal. The video signal obtained through the conversion is outputted to the display unit 112. The video signal processing unit 113 also outputs the menu image generated by the image generating unit 111 to the display unit 112 as a video signal, multiplexing the menu image with the decompressed content outputted from the demultiplexing-decompressing unit 114 when needed.

The demultiplexing-decompressing unit 114 demultiplexes and decompresses, according to the coding method that the compressing-multiplexing unit 105 has used, such as of MPEG-2 or H.264, content outputted from the reproducing processing unit 115. The decompressed content is outputted to the video signal processing unit 113.

The reproducing processing unit 115 reads the content to be reproduced from the recording medium 10. The read content is outputted to the demultiplexing-decompressing unit 114.

The recording medium 10 includes content 120 and the administrative information 121 regarding the content. The administrative information contains menu information according to which a disc menu image is generated. Also contained in the administrative information are reproduction order information and auxiliary information regarding partial reproduction and special reproduction.

The recording media described in the present embodiment refer to not only disc media but also any recordable media such as memory cards. The on-screen menus described in the present embodiment refer to lists of content items recorded on such media.

FIG. 3 shows a file structure recorded on a recording medium according to the present embodiment. As shown in FIG. 3, a content folder (CONTENTS) exemplarily contains an info file 11 (info), a menu file 12 (menu), a play list folder (PLAYLIST), a clip info folder (CLIPINF), a stream folder (STREAM).

The info file 11 (info) contains administrative information of a whole directory. The menu file 12 (menu) contains information for constructing a menu.

The play list folder (PLAYLIST) contains play list files such as a file 13 (01001.plst). The play list file 13 (01001.plst) contains information regarding the reproduction order of content items.

The clip info folder (CLIPINF) contains clip info files such as a file 14 (01000.clpi). The clip info file 14 (01000.clpi) contains a time table that enables partial reproduction and special reproduction by associating time information with locations of video data items.

The stream folder (STREAM) contains stream files such as a file 15 (01000.m2ts). The stream file 15 (01000.m2ts) contains audio and visual data.

The controlling unit 110 controls reproduction using files of three different types: the play list file 13, the clip info file 14, and the stream file 15.

The play list file lists clip info files to be reproduced and a reproduction time. When the play list file is reproduced, a specified clip info file is referred to and a stream file specified in the information in the time table is reproduced. For example, the play list file (01001.plst) specifies a reproduction order as a clip (#1) followed by a clip (#2). Here, for the clip (#1), the stream file (01000.m2ts) associated with the clip info file (01000.clpi) is reproduced. For the clip (#2), the stream file (02000.m2ts) associated with the clip info file (02000.clpi) is reproduced.

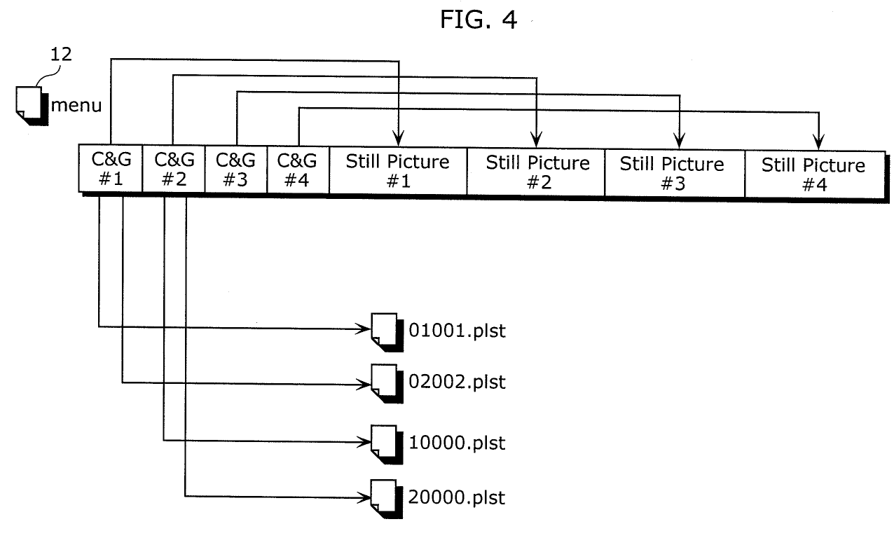

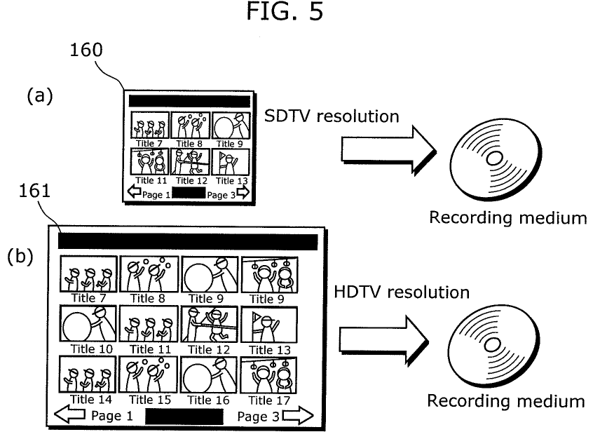

FIG. 4 shows a data structure in the menu file 12 according to the present embodiment. As shown in FIG. 4, described in the menu file 12 is a disc menu that lists the content items on the recording media 10 on one or more pages (see FIG. 5, for example).

Shown here is an example where the menu file 12 contains a series of C&Gs: C&G#1, C&G#2, C&G#3, and C&G#4, in this order from a beginning of the file. The C&Gs are associated with the play list files, respectively. The C&Gs are followed by Still Pictures such as Still Picture#1, Still Picture#2, Still Picture#3, and Still Picture#4, which are associated with the C&Gs, respectively. The C&Gs are data that include control information and image information.

The Still Pictures are data obtained through coding a background picture of the menu. An image that forms the background picture, such as a frame or a button, is associated with a command for controlling display of the menu.

For example, according to the C&G#1, the recording-reproducing apparatus 100 displays a menu on a first page that has, on a background picture thereof, thumbnail images of clips specified in the play list file (01001.plst). When a user operation to display a menu on a next page is accepted while the menu on the first page is displayed, a similar process is executed on the C&G#2 that follows the C&G#1. Specifically, a menu on a second page that has, on a background picture thereof, thumbnail images of clips specified in the play list file (02002.plst) is then displayed. The same applies to the C&G#3 and the C&G#4 that follow the C&G#2.

FIG. 5 shows a display example of an on-screen disc menu according to the present embodiment.

In the case where the medium information detecting unit 116 detects that a loaded recording medium is a conventional DVD, the recording processing unit 106 codes, as the Still Picture#1, a background picture with six thumbnail images of content items such as “Opening ceremony” and “Ball and basket game” thereon in SDTV image format. The medium information detecting unit 116 then records, in the C&G, the image information along with the control information. The image information is regarding an image (for example, an arrow indicating page 2 or a frame indicating whether or not there is a currently selected thumbnail image) that has a pixel count compatible with the picture and is changeable in color or shape by a user operation.

Thus, when a recording medium with a menu file recorded thereon is loaded on the recording-reproducing apparatus 100, the controlling unit 110, according to the C&G#1, uses the Still Picture#1 for the background picture. The controlling unit 110 superimposes the image information such as of the arrow, the frame, or the like on the background picture, and displays an on-screen menu 160 in SDTV format as shown in FIG. 5 (a). When the user selects one of the thumbnail images on the menu in order to reproduce a stream file and performs a reproduction operation, the controlling unit 110 refers to a play list file corresponding to the thumbnail image and reproduces the stream file.

In the case where the medium information detecting unit 116 detects that a loaded disc is a Blu-day disc or a recording media, even a DVD, on which content including an HDTV image is recorded using an image-compressing method of a high compression rate, the recording processing unit 106 codes, as the Still Picture#1, a background picture with 12 thumbnail images of content items thereon in HDTV format. The medium information detecting unit 116 then records, in the C&G, the image information along with the control information. The image information is regarding an image that has a pixel count compatible with the picture and is changeable in color or shape by a user operation.

Thus, when a recording medium with a menu file recorded thereon is loaded on the recording-reproducing apparatus 100, the controlling unit 110, according to the C&G#1, uses the Still Picture#1 for a background picture. The controlling unit 110 then superimposes the image information such as of the arrow, the frame, or the like on the background picture, and displays an on-screen menu 160 in HDTV format as shown in FIG. 5 (b).

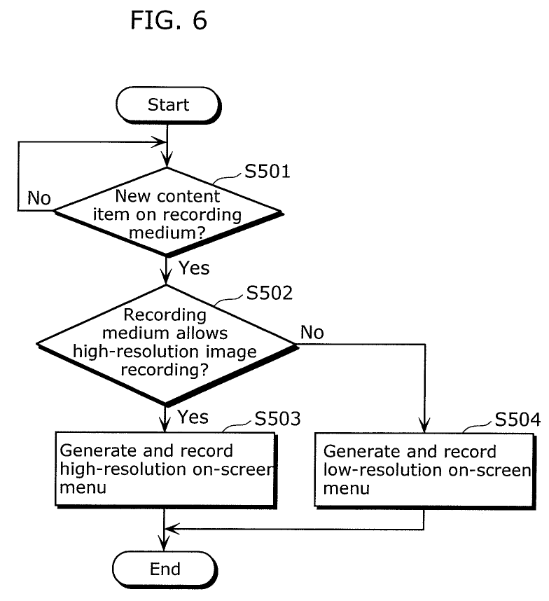

FIG. 6 is a flow chart showing an operating procedure in which the recording-reproducing apparatus according to the present invention generates and records an on-screen menu.

First, the recording-reproducing apparatus judges whether or not a new content item has been recorded on a recording medium (S501).

In the case where the new content item has been recorded on the recording medium, the medium information detecting unit 116 detects a type of the recording medium and judges whether or not the recording medium supports recording of a high-resolution image (S502). FIG. 6 describes the case where the medium information detecting unit 116 detects the type of the recording medium, but other items included in attribute information mentioned above may also be detected.

In the case where the medium information detecting unit 116 judges that the recording medium supports the recording of the high-resolution image (Yes in S502), the image generating unit 111 generates a high-resolution on-screen menu. The on-screen menu is recorded on the recording medium 10 via the recording controlling unit 108 (S503).

In the case where the medium information detecting unit 116 judges that the recording medium does not support the recording of the high-resolution image (No in S502), the image generating unit 111 generates a low-resolution on-screen menu The on-screen menu is recorded on the recording medium 10 via the recording controlling unit 108 (S504).

Thus, the recording-reproducing apparatus 100 according to the present embodiment detects, using the medium information detecting unit 116, attribute information of a loaded recording medium such as a media type, a remaining capacity, and a type of content recorded thereon. Next the recording-reproducing apparatus 100 generates an on-screen menu having a resolution appropriate for the recording medium using the image generating unit 111, and then records the generated on-screen menu on the recording medium using the recording controlling unit 108.

Because the recording-reproducing apparatus 100 according to the present invention records an on-screen menu appropriate for each type of recording media, a multi-drive recording-reproducing apparatus that supports both SDTV and HDTV images will display an on-screen menu having a resolution appropriate for either type of recording media. Moreover, even a non-multi-drive recording-reproducing apparatus with a single function will display an on-screen menu when such recording medium is loaded for compatible reproduction.

### INDUSTRIAL APPLICABILITY

A recording apparatus according to the present invention is applicable as an apparatus for recording audio and video on a portable recording medium, particularly as a DVD/BD-capable recording apparatus or a DVD/BD-capable video camera that records, on semiconductor memory or an optical disc, audio and visual data along with menu information for displaying an on-screen menu as needed.

1. A recording apparatus capable of recording an image on a first recording medium and on a second recording medium, the second recording medium supporting recording of a high-resolution image compared to the first recording medium, said recording apparatus comprising:
a detecting unit configured to detect whether a loaded recording medium is the first recording medium or the second recording medium according to information regarding the loaded recording medium;
an on-screen menu generating unit configured to generate an on-screen menu having a high resolution when said detecting unit detects that the loaded recording medium is the second recording medium, and an on-screen menu having a resolution lower than the high resolution when said detecting unit detects that the loaded recording medium is the first recording medium; and
a recording unit configured to record, on the loaded recording medium, the on-screen menu generated by said on-screen menu generating unit.

2. The recording apparatus according to claim 1,
wherein said detecting unit is configured to detect whether the loaded recording medium is the first recording medium or the second recording medium according to a type of the loaded recording medium,
said on-screen menu generating unit is configured to generate the on-screen menu having the high resolution when said detecting unit detects that the loaded recording medium is the second recording medium, or the on-screen menu having the resolution lower than the high resolution when said detecting unit detects that the loaded recording medium is the first recording medium, and
said recording unit is configured to record, on the loaded recording medium, the on-screen menu generated by said on-screen menu generating unit.

3. The recording apparatus according to claim 1,
wherein said detecting unit is configured to detect whether the loaded recording medium is the first recording medium or the second recording medium according to a capacity of the loaded recording medium,
said on-screen menu generating unit is configured to generate the on-screen menu having the high resolution when said detecting unit detects that the loaded recording medium is the second recording medium, or the on-screen menu having the resolution lower than the high resolution when said detecting unit detects that the loaded recording medium is the first recording medium, and
said recording unit is configured to record, on the loaded recording medium, the on-screen menu generated by said on-screen menu generating unit.

4. The recording apparatus according to claim 1,
wherein said detecting unit is configured to detect whether the loaded recording medium is the first recording medium or the second recording medium according to a type of content recorded on the loaded recording medium,
said on-screen menu generating unit is configured to generate the on-screen menu having the high resolution when said detecting unit detects that the loaded recording medium is the second recording medium, or the on-screen menu having a resolution lower than the high resolution when said detecting unit detects that the loaded recording medium is the first recording medium, and
said recording unit is configured to record, on the loaded recording medium, the on-screen menu generated by said on-screen menu generating unit.

5. The recording apparatus according to claim 1,
wherein said detecting unit is configured to detect whether the loaded recording medium is the first recording medium or the second recording medium according to a data transfer rate of the loaded recording medium,
said on-screen menu generating unit is configured to generate the on-screen menu having the high resolution when said detecting unit detects that the loaded recording medium is the second recording medium, or the on-screen menu having the resolution lower than the high resolution when said detecting unit detects that the loaded recording medium is the first recording medium, and
said recording unit is configured to record, on the loaded recording medium, the on-screen menu generated by said on-screen menu generating unit.

6. The recording apparatus according to claim 1, any of claim 1 to 5,
wherein said on-screen menu generating unit is configured to generate the on-screen menu having the high-resolution using a thumbnail image larger in size when said detecting unit detects that the loaded recording medium is the second recording medium than when said detecting unit detects that the loaded recording medium is the first recording medium.

7. A recording method for a recording apparatus capable of recording an image on a first recording medium and on a second recording medium, the second recording medium supporting recording of a high-resolution image compared to the first recording medium, said recording method comprising:
detecting whether a loaded recording medium is the first recording medium or the second recording medium according to information regarding the loaded recording medium;
generating an on-screen menu having a high resolution when said detecting detects that the loaded recording medium is the second recording medium, and an on-screen menu having a resolution lower than the high resolution when said detecting detects that the loaded recording medium is the first recording medium, and
recording, on the loaded recording medium, the on-screen menu generated by said generating the on-screen menu.

8. A program for a recording apparatus capable of recording an image on a first recording medium and on a second recording medium, the second recording medium supporting recording of a high-resolution image compared to the first recording medium, said program causing a computer to execute:
detecting whether a loaded recording medium is the first recording medium or the second recording medium according to information regarding the loaded recording medium;
generating an on-screen menu having a high resolution when said detecting detects that the loaded recording medium is the second recording medium, and an on-screen menu having a resolution lower than the high resolution when said detecting detects that the loaded recording medium is the first recording medium, and
recording, on the loaded recording medium, the on-screen menu generated by said generating the on-screen menu.

9. The recording apparatus according to claim 2,
wherein said on-screen menu generating unit is configured to generate the on-screen menu having the high-resolution using a thumbnail image larger in size when said detecting unit detects that the loaded recording medium is the second recording medium than when said detecting unit detects that the loaded recording medium is the first recording medium.

10. The recording apparatus according to claim 3,
wherein said on-screen menu generating unit is configured to generate the on-screen menu having the high-resolution using a thumbnail image larger in size when said detecting unit detects that the loaded recording medium is the second recording medium than when said detecting unit detects that the loaded recording medium is the first recording medium.

11. The recording apparatus according to claim 4,
wherein said on-screen menu generating unit is configured to generate the on-screen menu having the high-resolution using a thumbnail image larger in size when said detecting unit detects that the loaded recording medium is the second recording medium than when said detecting unit detects that the loaded recording medium is the first recording medium.

12. The recording apparatus according to claim 5,
wherein said on-screen menu generating unit is configured to generate the on-screen menu having the high-resolution using a thumbnail image larger in size when said detecting unit detects that the loaded recording medium is the second recording medium than when said detecting unit detects that the loaded recording medium is the first recording medium.
